(19) United States
(12) Patent Application Publication
(10) Pub. No.: US 2007/0247846 A1
(43) Pub. Date: Oct. 25, 2007

(54) Two Lamp Illumination System

(76) Inventor: Estill Thone Hall JR., Fishers, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/597,681

(22) PCT Filed: Jul. 7, 2004
(86) PCT No.: PCT/US04/21651

§ 371 Date: Nov. 21, 2006

Related U.S. Application Data
(60) Provisional application No. 60/574,498, filed on May 26, 2004.

(51) Int. Cl. F21V 7/00

(52) U.S. Cl. 362/247

(57) ABSTRACT

An illumination system is provided, comprising: two lamps (10) generating white light; an integrator rod (30) having an axis (31) disposed between the two lamps (10) for receiving the white light from the two lamps (10) at an input end (32) and directing the white light out of an output end (34) opposite the input end (32); and two mirrors (20) proximate the input end (32) of the integrator rod (30) and angled toward the respective lamps (10) to reflect the white light from the two lamps (10) into the input end of the integrator rod (30).

### CROSS-REFERENCE TO RELATED APPLICATIONS

This application claims the benefit of U. S. Provisional Patent Application Ser. No. 60/574,498, entitled “Optimized Two Lamp Illumination System” and filed May 26, 2004, which is incorporated by reference herein in its entirety.

### FIELD OF THE INVENTION

The invention relates to an illumination system utilizing two lamps to achieve effective brightness and extend lamp life.

### BACKGROUND OF THE INVENTION

In typical illumination systems, there is a trade-off between lamp brightness and lamp life. In order to achieve effective brightness, a higher wattage lamp is typically used at the expense of lamp life. Thus, devices using illumination systems with higher wattage lamps have short lives, requiring expensive lamp replacement.

### SUMMARY OF THE INVENTION

The invention provides an illumination system utilizing two lamps to achieve effective brightness and extended lamp life. The illumination system comprises: two lamps generating white light; an integrator rod having an axis disposed between the two lamps for receiving the white light from the two lamps at an input end and directing the white light out of an output end opposite the input end; and two mirrors proximate the input end of the integrator rod and angled toward the respective lamps to reflect the white light from the two lamps into the input end of the integrator rod.

### BRIEF DESCRIPTION OF THE DRAWINGS

The invention will now be described with reference to accompanying figures of which:

FIG. 1 shows an illumination system using two low wattage lamps according to an exemplary embodiment of the present invention;

FIG. 2 shows the illumination system of FIG. 1 with light paths from the two lamps;

FIG. 3 shows a graph of the light flux, as a percentage of flux from a single high wattage lamp, for two exemplary illumination systems using two low wattage lamps according to an exemplary embodiment of the present invention; and

FIG. 4 shows a geometric representation of an illumination system using two low wattage lamps according to an exemplary embodiment of the present invention.

### DETAILED DESCRIPTION OF THE INVENTION

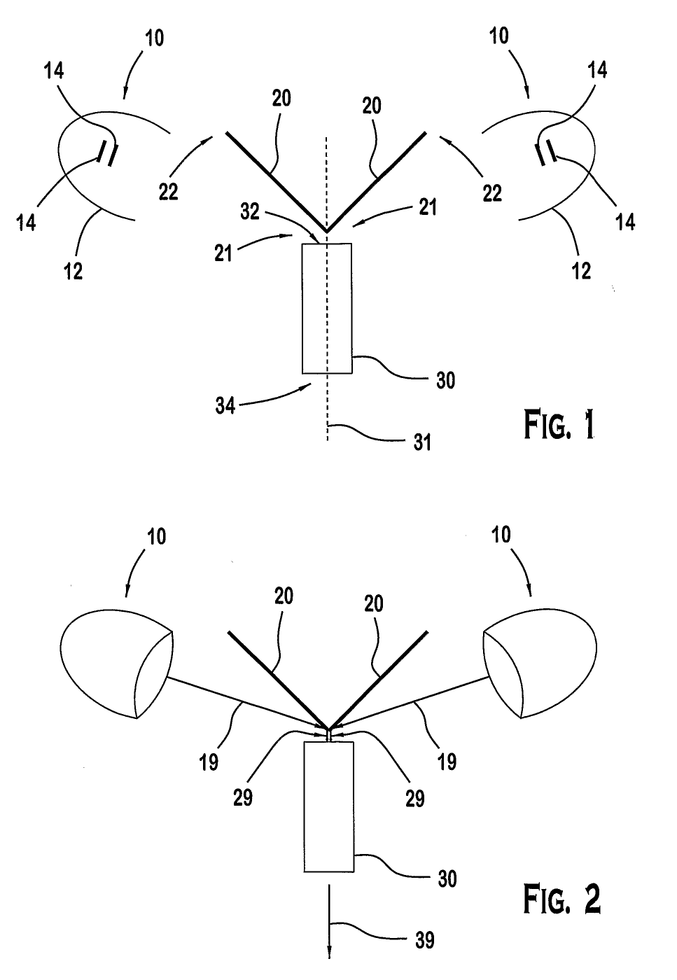

The present invention provides an illumination system utilizing two lamps to achieve effective brightness and extended lamp life. As shown in FIG. 1, the illumination system comprises two lamps 10, two angled mirrors 20, and an integrator rod 30. In an exemplary embodiment of the invention the two lamps each comprise a low wattage arc lamp such an ultra high performance (UHP) lamp, generating white light 19 and having a wattage of between about 100 and 120 Watts, available from Philips of Eindhoven, The Netherlands. Lamps of this wattage will have a significantly greater life than lamps typically used in a single lamp illumination system, having a wattage of about 180 to 200 Watts. The lamps 10 include reflectors 12 to focus and direct the light. Light is created by forming an electrical arc between two electrodes 14. The distance between these electrodes is referred to as the arc length, and is typically one of several standard arc lengths.

The integrator rod 30 is disposed between the two lamps 10, such that an axis 31 of the integrator rod 30 is at an essentially equal distance from each of the two lamps 10, and the integrator rod 30 is offset from the lamps 10 along the axis 31. The integrator rod has an essentially transparent input end 32 that is essentially perpendicular to the axis 31 and positioned toward the lamps 10. An essentially transparent output end 34 is essentially perpendicular to the axis 31 and positioned away from the lamps 10. While the integrator as shown in FIG. 1 has a square cross-section, a cylindrical integrator is also contemplated within the scope of the invention.

Two mirrors 20 are disposed approximately between the lamps 10, slightly offset along the axis 31 of the integrator rod 30. The mirrors 20 each have an essentially flat, rectangular reflective surface extending from a bottom edge 21 to a top edge 22. The bottom edges 21 are disposed proximate the input end 32 of the integrator rod 30. In an exemplary embodiment of the invention, the bottom edges 21 of the mirrors 20 meet at the axis 31 of the integrator rod 30. The mirrors are angled with respect to the axis 31 of the integrator 30 to optimize the reflection of white light 19 from the respective lamps 10 into the input end 32 of the integrator rod 30, as will be described in greater detail below.

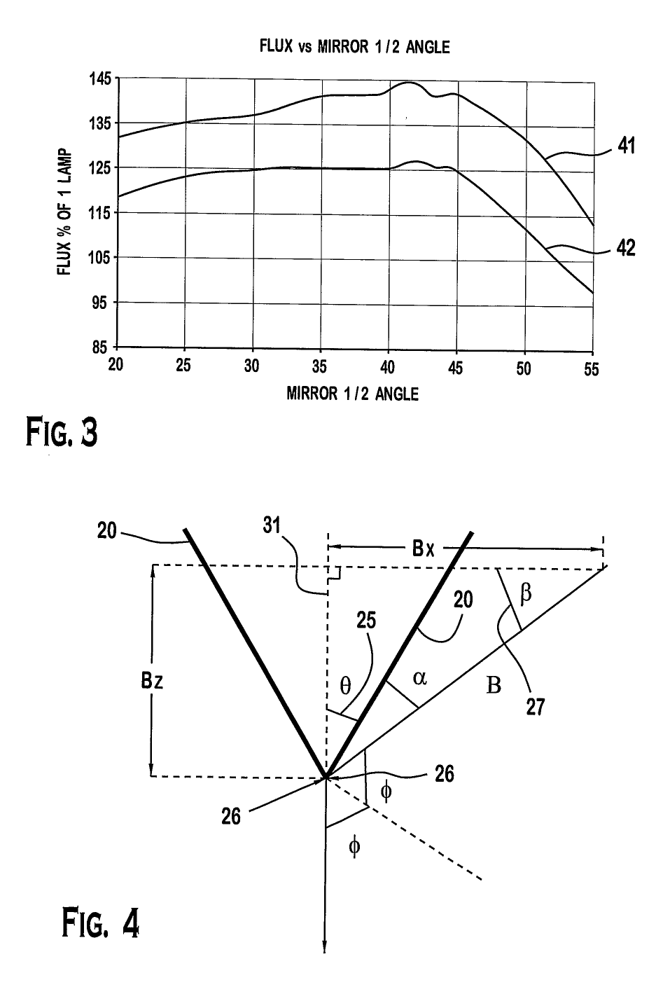

As shown in FIG. 2, the white light 11 from the lamps 10 is directed onto the respective mirrors 20, at positions 26 (shown in FIG. 3) proximate to the bottom edges 21 thereof. Reflected light 29 from each of the mirrors 20 enters the integrator rod 30 at the input end 32, and an integrated light beam 39 exits the output end 34 of the integrator rod 30 essentially along axis 31.

The inventors have determined that the flux of the integrated light beam 39 varies with the arc length of the lamps and with the angle of the mirrors 20 to axis 31 of the integrator rod 30, referred to as the mirror half angle because it is half of the included angle between the two mirrors 20. FIG. 3 shows calculated curves 41, 42 for light flux of integrated light beam 39 as a percentage of the light flux for a single lamp over a range of mirror half angles for lamps having an arc length of 1.0 mm and 1.3 mm, respectively. It should be noted that the peak flux occurs at a different half angle for the different arc lengths.

FIG. 4 shows a geometric representation of the illumination system of the invention. Theta 25 is the angle between the axis 31 of the integrator rod (not shown in FIG. 3) and one of the mirrors 20. The vector B represents the white light 11 generated by one of the lamps 10, having a length equal to the focal length of the lamps 10, at an angle Beta 27 from a horizontal axis perpendicular to the axis 31 of the integrator rod 30. The angle Beta 27 is 45 degrees. Therefore components Bx and By of the vector perpendicular and parallel, respectively to the axis 31 are each equal to the magnitude of vector B divided by √2.

A number of conflicting geometrical factors affect the optimum angle for the mirrors 20 and the optimum position for the lamps 10 with respect to the mirrors 20 and the integrator rod 30. Among these factors are: finite beam size, rays being blocked by the outside of the integrator rod, and rays reflected off of the mirrors that miss the input end of the integrator. The inventors have determined the angle for the mirrors 20 and position for the lamps 10 using a system analysis program. The calculated optimum values for the angle of the mirrors 20 with respect to the axis 31 of the integrator rod 30 for two exemplary arc lengths are provided in Table A as Theta. The optimum positions for the lamps are provided as Delta X and Delta Y, where Delta X is the calculated distance of the optimum position in a direction perpendicular to (and away from) the axis 31 of the integrator rod 30 from the origin of vector B having a magnitude equal to the focal length of the lamps 10 at an angle of 45 degrees from the axis 31 of the integrator rod 30. Similarly, Delta Y is the calculated distance of the optimum position in a direction parallel to the axis 31 of the integrator rod 30 from the origin of vector B (and away from the integrator rod 30).

TABLE A

| lamp arc length | Theta | Delta X | Delta Y |
|---|---|---|---|
| 1.0 mm | 41 degrees | −13.85 mm | +0.315 mm |
| 1.3 mm | 42 degrees | −12.95 mm | +1.05 mm |

The calculated light flux for the illumination systems having a 1.0 mm and 1.3 mm arc length and the mirror angles and positioning of table A are 144.34% and 126.88%, respectively of a single lamp illumination system using the same lamp.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An illumination system, comprising:
two lamps generating white light;
an integrator rod having an axis disposed between the two lamps for receiving the white light from the two lamps at an input end and directing the white light out of an output end opposite the input end; and
two mirrors proximate the input end of the integrator rod and angled toward the respective lamps to reflect the white light from the two lamps into the input end of the integrator rod.

2. The illumination system of claim 1 wherein the mirrors are tilted at an angle of between about 40 degrees and 45 degrees from the axis of the integrator rod.

3. The illumination system of claim 2 wherein the two mirrors meet at respective edges thereof essentially on the axis of the integrator rod.

4. The illumination system of claim 1 wherein the lamp has an arc length of about 1.0 mm and the mirrors form an angle of between about 40.5 degrees and 41.5 degrees from the axis of integrator rod.

5. The illumination system of claim 1 wherein the lamp has an arc length of about 1.0 mm and the mirrors form an angle of about 41 degrees from the axis of integrator rod.

6. The illumination system of claim 4 wherein the lamps are directed toward a point on the respective mirrors proximate the input end of the integrator rod.

7. The illumination system of claim 6 wherein the lamps are disposed at a distance from the point on the respective mirror where they are directed that is less than the focal length of the lamps.

8. The illumination system of claim 6 wherein the lamps are disposed at points that are offset from the end points of respective vectors originating at the point on the respective mirrors where the lamps are directed and having an angle of 45 degrees from the axis of the integrator rod and a length equal to the focal length of the lamps by a distance of about 0.315 mm away from the input end of the integrator rod and a distance of about 13.85 mm in the direction of the axis of the integrator rod.

9. The illumination system of claim 1 wherein the lamp has an arc length of about 1.3 mm and the mirrors form an angle of between about 41.5 degrees and 42.5 degrees from the axis of integrator rod.

10. The illumination system of claim 1 wherein the lamp has an arc length of about 1.3 mm and the mirrors form an angle of about 42 degrees from the axis of integrator rod.

11. The illumination system of claim 9 wherein the lamps are directed toward a point on the respective mirrors proximate the input end of the integrator rod.

12. The illumination system of claim 11 wherein the lamps are disposed at a distance from the point on the respective mirror where they are directed that is less than the focal length of the lamps.

13. The illumination system of claim 11 wherein the lamps are disposed at points that are offset from the end points of respective vectors originating at the point on the respective mirrors where the lamps are directed and having an angle of 45 degrees from the axis of the integrator rod and a length equal to the focal length of the lamps by a distance of about 1.05 mm away from the input end of the integrator rod and a distance of about 12.95 mm in the direction of the axis of the integrator rod.

14. The illumination system of claim 1 wherein each lamp has a lower wattage than a single lamp system providing the same brightness.
